(19) United States
(12) Patent Application Publication
(10) Pub. No.: US 2003/0157332 A1
(43) Pub. Date: Aug. 21, 2003

(54) Continuous, monoatomic thick materials

(76) Inventor: Joseph D. Udy, Aurora, CO (US)

Correspondence Address: Joseph D. Udy, Apt. # 362, 4466 S. Helena Way, Aurora, CO, 80015-4415, US

(21) Appl. No.: 10/079,376

(22) Filed: Feb. 20, 2002

(51) Int. Cl. B32B 9/00

(52) U.S. Cl. 428/408; 428/332

(57) ABSTRACT

Continuous, monoatomic thick graphite sheets/ribbons are potentially produced utilizing laser desorption techniques. These techniques and other are generalized toward production of continuous, monoatomic/molecular thick materials.

### BACKGROUND

1. Field of Invention

This invention relates to a one-atom/molecule thick, continuous sheet of material, specifically to a continuous, monoatomic thick, sheet of graphite, of any desired width.

2. Discussion of Prior Art

Molecular/atomic beam epitaxy methods and pulsed laser deposition methods have been used to deposit very thin layers of material, in some cases, one molecule/atom thick, onto various substrates, usually with small surface area (U.S. Pat. No. 6,316,098, “Molecular layer epitaxy method and compositions”, to Yitzchaik, Nov. 13, 2001 and U.S. Pat. No. 6,342,313, “Oxide films and process for preparing same” to White, Jan. 29, 2002). Some wet chemical methods will deposit a layer of material, sometimes one atom/molecule thick, onto a substrate or floating on a liquid surface (U.S. Pat. No. 5,942,286,“Method for manufacturing organic monomolecular film”, to Ohno, Aug. 24, 1999). Continuous filament is described in U.S. Pat. No. 6,309,423, “Self-cohering, continuous filament non-woven webs”, to Hayes, Oct. 30, 2001.

Graphite exists naturally “. . . in two forms: foliated and amorphous . . . in general, artificial graphite made at high temperature in the electric furnace is now preferred for most uses because of its purity.” (Materials Handbook, 10th Edition, G. S. Brady. pg. 374).

### SUMMARY

Continuous sheets/ribbons of material, one-atom/molecule thick, are potentially formed by laser desorption/ionization (LDI) of precursor molecules/atoms.

### OBJECTS AND ADVANTAGES

Graphite is very strong along the two dimensions of its structural plane. The production of continuous sheets of graphite would allow the fabrication of high strength, light weight structures.

Graphite conducts heat and electricity along the two dimensions of its structural plane. The production of continuous sheets of graphite would allow the fabrication of unique, heat, and/or electricity conducting devices/structures.

### DRAWINGS

No drawings accompany this application.

### DESCRIPTION

The lower surface of a cylinder or drum is in contact with a reservoir of precursor material. As the drum rotates, a thin layer of material coats the surface of the drum. The precursor material on the top surface of the coated, rotating drum is irradiated with lasers. Laser desorption/ionization activates the precusor material which polymerizes or “self-assembles” into a sheet on the drum surface. (Additional activation methods include heat, pressure, catalysts, reactive species, enzymes, and combinations.) This sheet of material is formed continuously as the drum rotates, and the reservoir of precursor material is maintained in contact with the lower surface of the drum.

This continuous sheet of material is drawn off of the drum surface as it is formed and collected by winding it onto a take-up roll.

Operation—Preferred Embodiment

A rotating drum, likely stainless steel, the same length as the desired width of the graphite sheet, is barely immersed in a reservoir (heated bath) of 1,3,5,-trichlorobenzene. As the drum rotates, the lower surface of the drum is wetted by the trichlorobenzene. At the top of the rotation cycle, the 1,3,5-trichlorobenzene on the drum surface is irradiated with nitrogen lasers (laser desorption/ionization) with a wavelength about 337 nm and with laser fluences adjusted to maximize, continuous, monoatomic graphite sheet formation, likely at the threshold for ion formation. The hydrogen and chlorine ions are desorped, and combine to form hydrogen chloride gas which is removed, and recycled,or bubbled through a sodium hydroxide solution, to form sodium chloride (salt) and water.

The benzene ions, which never really exist separately, combine to form a continuous, one-atom thick graphite sheet. It is likely that this formation of the graphite sheet would be an example of “self-assembly”. (A second set of lasers, at the resonance frequency of the benzene ions may be needed). As the graphite sheet is formed, it is continuously drawn off and wound onto a take-up roll.

A series of scanning tunneling microscope arrays would likely be needed to visualize the graphite sheet. Zero defects are required in the graphite sheet, atomic force microscope probes could likely repair any defects before the graphite sheet is wound onto the take-up roll.

This monoatomic graphite sheet formation produce would likely require a nitrogen and oxygen free atmosphere to reduce defects in the graphite structure. A low temperature drum surface, in the area of the laser irradiation, may reduce defects in the graphite structure. Also, a static, thin layer of graphite on the drum surface, to act as a template for the continuous graphite sheet formation, may reduce defects. A slight electrical charge (perhaps pulsed) on the drum may also reduce defects. Very short laser pulses, picosecond or femtosecond, may reduce defects.

Alternatively, if continuous, monoatomic graphite ribbons are desired, the laser irradiation could be restricted to the desired ribbon width.

Conclusion, Ramifications and Scope

It is likely that other materials including: silicon, boron, sulphur, protiens, and others/combinations can be formed into monoatomic/molecular thick, continuous sheets with appropriate activation methods and formation surfaces. These efforts may spur new research in both organic and inorganic continuous sheet alloys.

Graphite conducts electricity, and might be used as a wiring grid for nanocircuits, by optimumly placing components on a graphite sheet and then photoetching out undesired connections.

A continuous ribbon of graphite could be created the same width as the circumferance of a carbon nanotube. Laser desorption/ionization could likely be used to attach the two sides of the graphite ribbon together, thereby creating a continuous graphite nanotube. This protocol could likely be used to create graphite tubes of any diameter. A thread, rope or wire of concentric, layered, continuous graphite tubes, with slightly increasing diameters, might be superconducting, with appropriate “doping”.

Continuous graphite sheets could likely be molded/formed into/to any compound shape. Many cylindrical structures including, gun barrels and aircraft/rocket bodies could be created by winding a continuous graphite sheet around an appropriate sleeve or form. These graphite layers could be laminated (glued together) or possibly allowed to move with respect to adjacent layers thereby dissipating energy and likely reducing vibration and fatigue-cracking problems.

A few layers of graphite sheet would likely create an air barrier, appropriate for use as aircraft wing skin, boat sails, ballons, or kites, ect. Noncontinuous graphite sheet(s) may have interesting uses as “filters” and/or permeable membranes, perhaps in batteries or fuel cells.

1. Means to produce monoatomic/molecular thick, continuous sheets of material.

2. The material of claim 1, wherein said material is graphite.

3. The continuous sheets of claim 1, further including ribbons.

4. The continuous sheets of claim 1, further including continuous sheets more than one atom/molecule thick.

5. The sheets of claim 1, further including noncontinuous sheets.
